(19) United States
(12) Patent Application Publication
(10) Pub. No.: US 2015/0084784 A1
(43) Pub. Date: Mar. 26, 2015

(54) APIARY MONITORING SYSTEM

(71) Applicant: Solutionbee, LLC, Raleigh, NC (US)

(72) Inventors: Valentin Suta, Timisoara (RO); Ionut Adrian Nicorescu, Timisoara (RO); Cristian Cornel Cucuiet, Timisoara (RO); Smaranda Diana Pliuta, Timisoara (RO); Lucian Vasile Timar, Timisoara (RO); Ovidiu Vetres, Timisoara (RO); Rafael Cabrera, Raleigh, NC (US); Scott Turner Holdsclaw, Raleigh, NC (US); David Nitescu, Timisoara (RO); Marcel Dragos, Dumbravita (RO)

(21) Appl. No.: 14/496,734

(22) Filed: Sep. 25, 2014

Related U.S. Application Data
(60) Provisional application No. 61/882,391, filed on Sep. 25, 2013.

(51) Int. Cl. A01K 47/06; G08C 17/02; H04W 52/04

(52) U.S. Cl. CPC A01K 47/06; H04W 52/04; G08C 17/02; G08C 2200/00
USPC 340/870.01

(57) ABSTRACT

A system for monitoring an comprises a hive monitor configured for measuring and transmitting data on hive parameters, a data collector communicating with the hive monitor for logging measurement data received from the hive monitor, the data collector configured for transmitting the logged data, and a central database repository communicating with the data collector for storing the logged data received from the data collector. The hive monitor comprises a controller, a power source for powering the controller, a load cell for measuring the weight of the hive, means for measuring parameters of the hive, and means for communicating measured data.

### CROSS-REFERENCES

This application is related to U.S. provisional application No. 61/882,391, filed Sep. 25, 2013, entitled “APIARY MONITORING SYSTEM”, naming Valentin Suta, et al. The contents of the provisional application are incorporated herein by reference in their entirety, and the benefit of the filing date of the provisional application is hereby claimed for all purposes that are legally served by such claim for the benefit of the filing date.

### BACKGROUND

A system for monitoring an apiary is described and, more particularly, a system for monitoring conditions of one or more bee hives and transmission of data to a central repository through a data collector.

Honey bees are a vital part of agriculture in America and around the world. In addition to honey production, honey bees play an even more vital role in the pollination of agricultural crops.

Approximately one third of all food consumed in the U.S. is pollinated by honey bees. Therefore, the health of bee colonies is important not only for the environment in general, but for our food supply as well.

Beekeeping requires numerous inspections during a year to evaluate the health of the hive and to determine if and when additional actions may be necessary, such as installation of additional sections or components of a hive referred to as “deeps” or “supers”, whether a hive needs to be split or combined with another hive, and whether auxiliary feeding or medication is necessary. Additionally, knowing other real-time or near real-time parameters that are not evident during an infrequent inspection is useful as well. These parameters may include temperature and humidity to insure that there is sufficient ventilation during the summer, and if the hive is warm enough in the winter. Acoustic monitoring and bee counting can tell if there is sufficient activity, if there are unwanted pests in the hive, or if the hive is about to swarm. Motion sensors or accelerometers can be useful in detection of thefts, whether human or bear.

Additionally, a major problem has arisen in the last several years called Colony Collapse Disorder (CCD) in which bee colonies abruptly disappear. The USDA reported in 2012 that a number of factors continue to be associated with CCD, including parasites and pathogens, poor nutrition, pesticides, bee management practices, habitat fragmentation, and agricultural practices, no single factor or pattern of factors has been proven to be “the cause” of CCD. Additional research is ongoing, and monitoring of additional parameters, which may not be defined at this time, could also be useful to researchers in the future.

Monitoring of bee hives is useful to all types of beekeepers: commercial, amateur and researchers, although different users may be interested in different monitored parameters. U.S. Pat. No. 6,910,941 to Bromenschenk et. al describes an electronic bee colony monitoring system which uses multiple input transducers, a microprocessor to interpret and handle data, and multiple output signals capable of controlling remote devices which may be transmitted by wired or wireless means. However, Bromenschenk et al. requires a full system for each hive being monitored.

Wired data transmission is specifically referred to as telephone, but any “wired” communications system would only be practical in locations where the hives would be in fixed locations, and dedicated phone lines to multiple monitors would be expensive. Conversely, wireless data transmission is specifically referred to as cellular radio and satellite communications. Although the USDA has found no connection between CCD and cell phones or cell towers in normal operation, there is evidence that cell phones in direct proximity to a hive, and operated for 10 minutes a day, is sufficient to disrupt the navigational skills of worker bees to the point that they are unable to return to the hive once they leave (Sainudeen, Sahib, Electromagnetic Radiation (EMR) Clashes with Honey Bees, International Journal of Environmental Sciences, Volume 1, No 5, 2011). So use of higher powered cell phones or satellite phones for transmission of monitored data could have a detrimental effect on the hive that it is attempting to help.

Finally, as mentioned above, there are a number of different types of users with different interests and different levels of willingness to adopt new technology. Beekeeping has been done for a very long time in much the same manner, and in a very “low tech” fashion. It is expected that many of the beekeepers themselves are not going to be “tech-savvy”. In order for the system to be of interest to these users, any setup and configuration needs to be absolutely minimal There will be other users who will want to “play” with the devices and data, and these users will want to be able to do more specific configurations to make the devices function to fit their desires. And then there will be users who will want to use the system to do research type studies and may want to configure the systems to operate in a manner significantly different from the more typical users since they may be looking for different data. So part of the challenge is to develop a system that allows all of the users to be able to utilize the system with the varying amounts of personal interaction that may be required.

### SUMMARY

A system for monitoring one or more bee hives in an apiary is described. The apiary monitoring system comprises a hive monitor configured for measuring and transmitting data on hive parameters, a data collector communicating with the hive monitor for logging measurement data received from the hive monitor, the data collector configured for transmitting the logged data, and a central database repository communicating with the data collector for storing the logged data received from the data collector.

A hive monitor for monitoring a bee hive comprises a controller, a power source for powering the controller, a load cell for measuring the weight of the hive, means for measuring parameters of the hive, and means for communicating measured data. A method of operating of the hive monitor comprises the steps of selecting a measurement to be made of a parameter of the beehive, performing the measurement of the parameter, determining if the measurement has an alarm condition to be tested, and testing the measurement for the alarm condition.

A data collector for use in an apiary monitoring system for monitoring one or more bee hive monitors comprises a controller, a power source for powering the controller, means for low power communication, a user interface including means for user input, and non-volatile memory for storing logged data readings from the hive monitors.

A primary element of the apiary monitoring system is the hive monitor. Wired connections from the one or more hive monitors may be used in the cases where the hives have a fixed location. Alternatively, the hive monitors may use a low power wireless communications path such as IEEE 802.15.4 communications. The lower power transmissions would be made to a centrally placed data collector, a second element of the monitoring system. The data collector would be responsible for communicating with all of the hive monitors within some specified distance over the low power wireless signal, for example a radius of about 100 feet, which may change with other technologies. The data collector would then store all of the sets of readings from all of the hive monitors with which it had communicated, and then transmit the data in turn to a central database repository, typically expected to be a server on the internet.

The monitoring system has the benefit of lower RF power levels from the monitors at the actual hives being required to transmit the data, which is less likely to be detrimental to the bees. The monitoring system also provides a cost benefit for the monitors by allowing a less expensive radio to be used as opposed to having to have a cellular or satellite phone for each hive.

The central database repository is common to all data collectors for all users. Each user may have their own sign in and password to allow access to a user interface where their specific data is compiled, processed, viewed and archived. Additionally, the interface provides a location where remote configuration changes may be made that would be applied to an individual monitor, or all monitors, assigned to the user. Finally, each user may allow access to part or all of their data to researchers, allowing the researchers larger volumes of data from which to do analysis.

Another aspect of the monitoring system is a portable configuration device (PCD 16). The portable communication device is typically used to input data specific to individual monitors when they are originally installed or when modifications are made over time. This device may comprise any computer with an appropriate communications path. In one embodiment the portable communication device may be a smart phone or tablet computer since they are already typically equipped with a camera, low power communications such as Bluetooth, as well as a GPS receiver and internet connectivity. As part of the initialization process, the PCD 16 is used to identify hive and monitor specific information, for example, by using a camera to read bar codes or by typing in identification information from the monitor nameplate and hive components, as well as to potentially transmit the present location GPS coordinates to the monitor itself.

### BRIEF DESCRIPTION OF THE DRAWINGS

For a more complete understanding of the present invention, reference should now be had to the embodiments shown in the accompanying drawings and described below. In the drawings:

FIG. 1 is a block diagram of an embodiment of an apiary monitoring system.

FIG. 2 is a block diagram of an embodiment of a hive monitor for use in an apiary monitoring system.

FIG. 3 is a flow chart showing a method of operation of the hive monitor.

FIG. 4 is a block diagram of the an embodiment of a data collector for use in an apiary monitoring system.

FIG. 5 is front perspective of an embodiment of a data collector for use an apiary monitoring system.

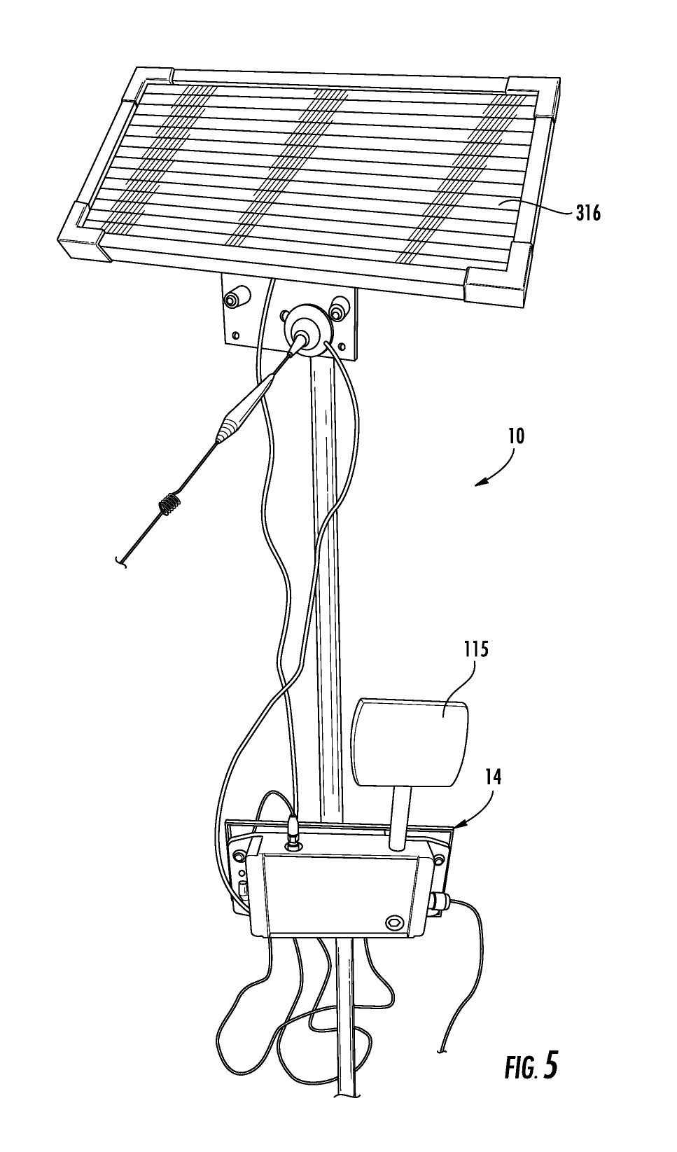

FIG. 6 is front perspective of an upper portion of the data collector as shown in FIG. 5.

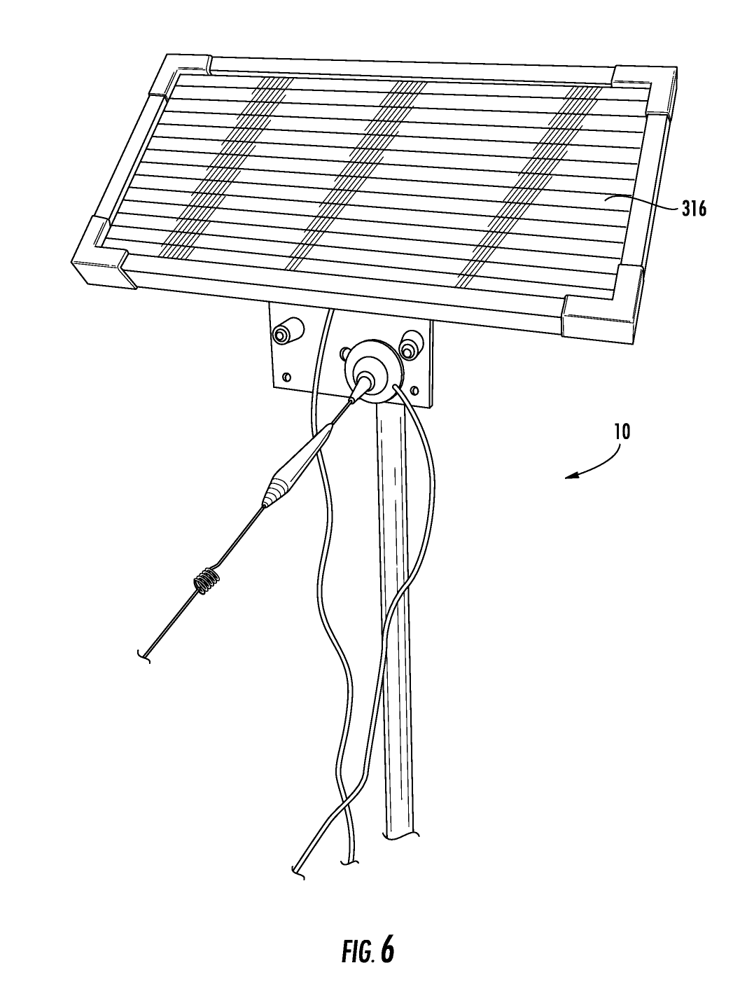

FIG. 7 is front perspective of a lower portion of the data collector as shown in FIG. 5.

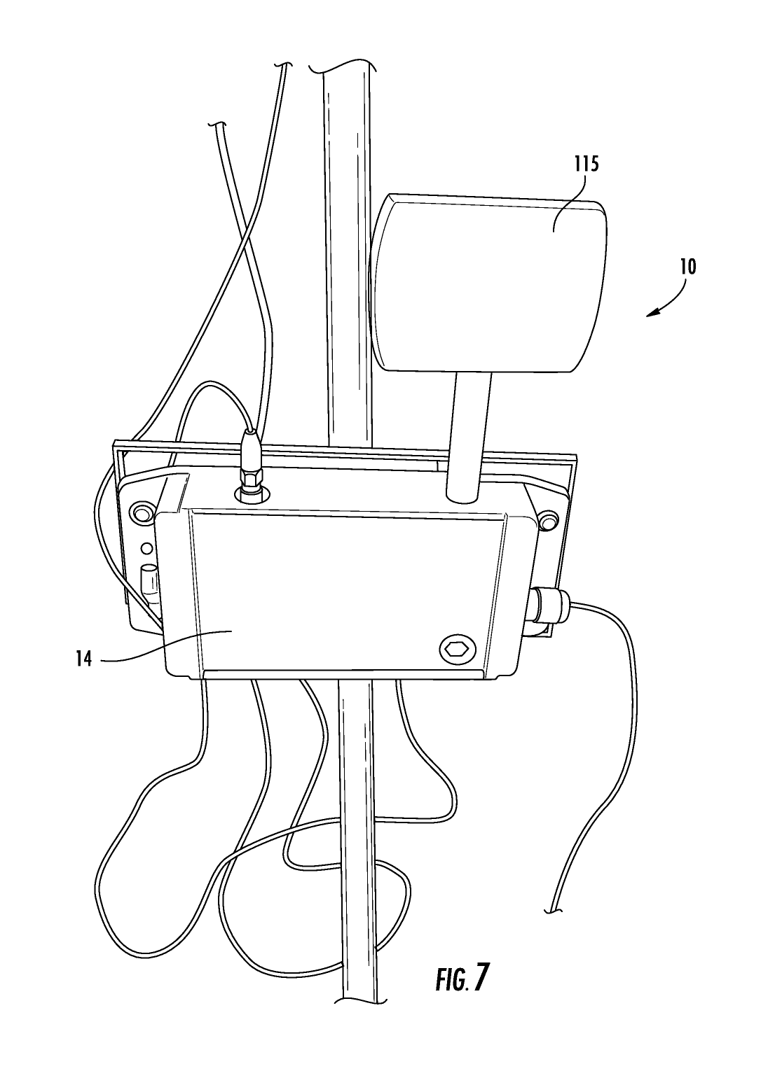

FIG. 8 is front perspective of an embodiment of a bee hive including an apiary monitoring system.

### DESCRIPTION

An apiary monitoring system allows the monitoring of one or more bee hives and remote access to the data. The monitoring system is comprised of one or more hive monitors, which collect information from bee hives at short time intervals and store the data sets. Data collectors retrieve the information directly from one or more monitors at longer time intervals, and the data collectors transmit data to a central database repository where data from all hives may be viewed, processed and acted upon if necessary. A portable configuration device functions to input site specific information, typically at time of installation.

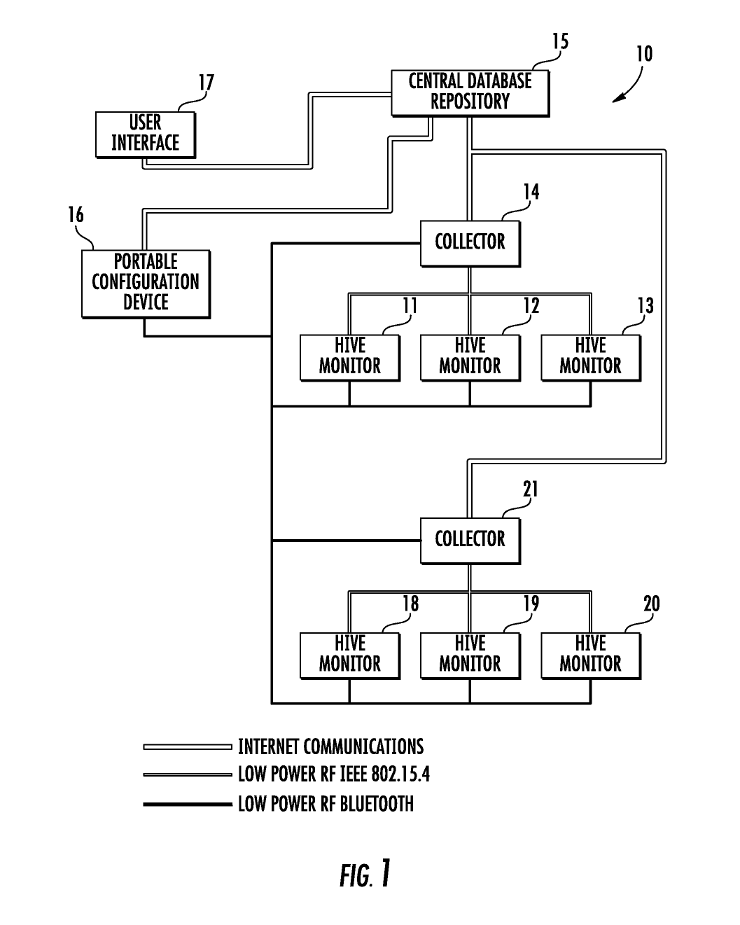

Referring to FIG. 1, a block diagram shows the components of an embodiment of an apiary monitoring system, which is generally designated at 10. The monitoring system 10 comprises a first set of hive monitors 11, 12, 13. Each monitor 11, 12, 13 communicates with a data collector 14, such as via low power IEEE 802.15.4 RF communications, and passes alarm indications to the collector when detected, as well as passing logged data to the collector when requested to do so. The collector 14 in turn passes time and date synchronization information as well as any configuration changes down to the monitors as required. The collector 14 in turn passes the data up to a central database repository (CDR) 15 which stores and archives the information from all collectors and monitors. The data link from the collector 14 to the CDR 15 may be a number of different options, including cell phone, satellite phone, telephone land line, WiFi, and the like. In one embodiment the collector 14 accesses the internet in order to pass the information to the CDR, wherein the CDR is implemented as a server on the internet for ease of access from most any location. Also in FIG. 1, a second set of hive monitors 18, 19, 20 are configured by a portable configuration device 16. The hive monitors 18, 19, 20 pass their information up to a second data collector 21, most commonly due to physical separation between different monitors and collectors. The second collector in turn passes its logged information to the same CDR 15, and again may do so by whichever means collector 21 is configured to use. A user Interface 17 is used to view, analyze, export or otherwise process the collected data from the different collectors 14, 21 and monitors 11, 12, 13, 18, 19, 20 associated with a specific user. It is understood that the three hive monitors depicted in each set of hive monitors is merely exemplary, and the number of hive monitors may be as few as one monitor or as many as hundreds or thousands of hive monitors simply depending on the proximity of the monitors to a data collector and the range of the means for communication with the data collector, for example, low power RF (Bluetooth).

Other embodiments of an apiary monitoring system are contemplated. In one embodiment, the portable configuration device 16 may be used to manually read information from a data collector 14, in place of direct communications with the CDR 15. In an even simpler embodiment, a user reads one or more of the hive monitors 11, 12, 13 manually with the portable configuration device 16.

Referring to only one hive monitor 11, each hive monitor 11 is a battery-powered device that is attached to an individual bee hive. One monitor 11 is required for each hive 30 in a system 10. The monitor 11 keeps track of real time data, and also stores a variety of configuration parameters, such as monitor serial number, MAC ID, reading time periods and various alarm threshold values. The monitor 11 periodically takes measurements, for example, once every 15 minutes, of a variety of parameters such as weight, temperature, humidity, physical location (GPS coordinates), positioning (physical orientation of hive), acoustic information, and the like. and time-stamps each set of information. The measurements taken vary based on which measurement capabilities are available on each individual monitor. The monitor 11 also does immediate processing on the information in order to determine if any alarm conditions have occurred. The monitor stores these pieces of information for each measurement period, and at a slower periodic interval, for example, twice per day, uploads the logged information to a data collector 14 at the request of the collector. However, if any of the alarm monitors have been tripped, then the monitor 11 immediately passes an indication up to the collector 14. The collector 14 may then read the monitor 11 when time is available, and then decide what to do with the information.

Communication from the hive monitor 11 to the data collector 14 may be wired or wireless, although the most common and most convenient methodology is low power wireless. One embodiment of the hive monitor 11 uses both Bluetooth and IEEE 802.15.4 wireless communications. Bluetooth may be used for communications between the hive monitor 11 and a portable configuration device 16. This communications link is used for initialization of the monitor, updating of monitor information, reading of individual pieces of monitor information or full reads of logged parameter data. IEEE 802.15.4 wireless communications between the monitor 11 and the collector 14 could be Zigbee or proprietary protocols, but in either case the intention is to make the communications as low power as possible for the desired communication ranges. It is understood that the apiary monitoring system 10 contemplates use of other present or future low power technologies for the communications pathways.

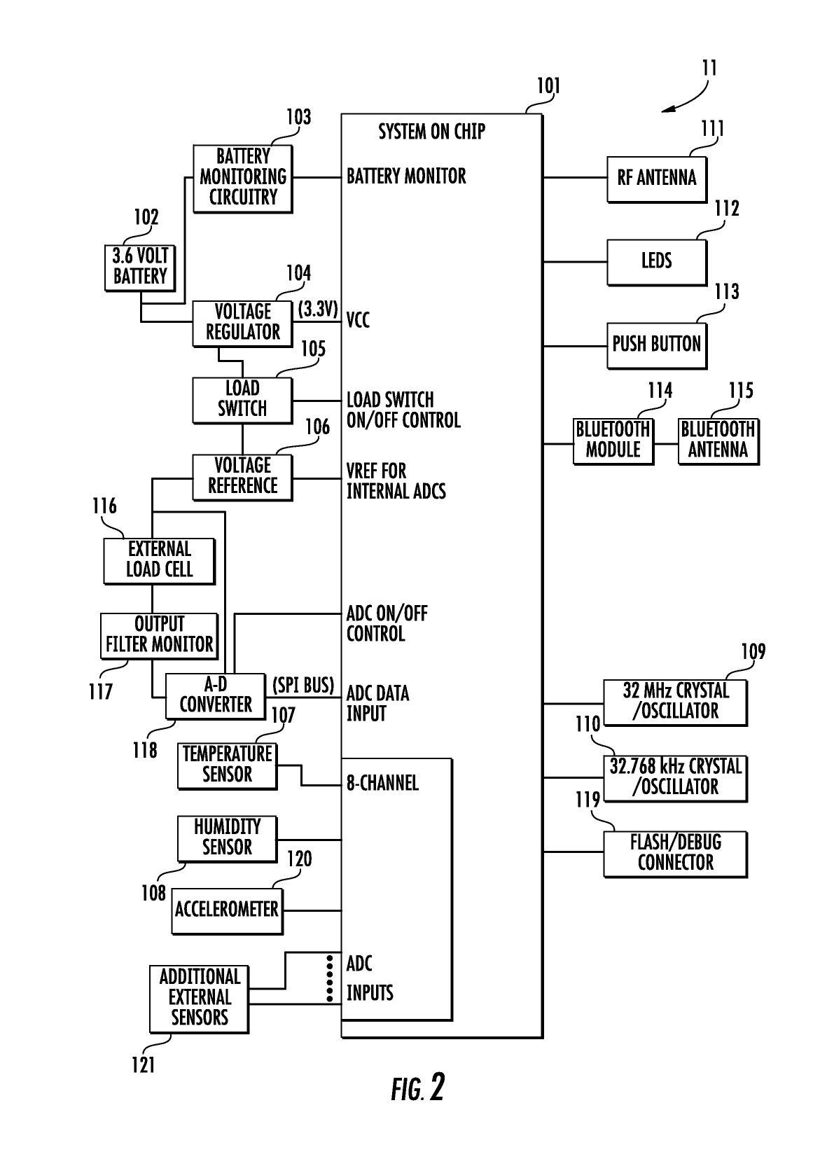

FIG. 2 is a block diagram showing functional components of an embodiment of a hive monitor 11 for use in the apiary monitoring system 10. As shown in FIG. 2, the monitor 11 comprises a main system on chip (SOC) controller 101 around which the other parts are built. A 3.6 volt battery 102 is used as a primary power source, and a battery monitoring circuit 103 is used to pass a signal on to the SOC 101 to determine when the battery is about depleted. A 3.3 volt voltage regulator 104 converts the battery voltage to a lower voltage of 3.3V for use as the supply voltage for most of the other components of the hive monitor 11. A voltage reference 106 is used to generate a reference voltage for both internal and external analog to digital converters (ADC's). A commonly expected measurement device is a load cell 116 which is used to measure weight of the hive. The output of the load cell 116 is run through an output filter 117, and the filter output is run into an external ADC 118. Output readings from the external ADC are fed back to the SOC 101 via a serial data bus (SPI in the embodiment shown). An external temperature sensor 107, a humidity sensor 108, and an accelerometer 120 also feed into the internal ADC inputs on the SOC 101. Capabilities are present to allow additional external sensors 121 to also be input, which may include, but are not limited to, measurement devices such as microphones, additional temperature sensors, or other desired inputs. An external load switch 105 is controlled by the SOC 101 and is used to disable the circuitry that allows for operational measurements. This is to reduce power drain to an absolute minimum when operational measurements are not being made for extended battery life. Similarly, a control line from the SOC 101 is passed to the external ADC 118, which may disable the load cell operation when it is not needed without disabling the voltage reference 106, which is used for other external sensor inputs to the internal ADCs. An antenna 111 for low power RF (IEEE 802.15.4) communications to a data collector 14 is included, as well as a low power RF module (Bluetooth) 114 and antenna for Bluetooth communications 115, which will be used to communicate with the portable configuration device 16. A push button 113 is available for direct user input to force a variety of operations by the Hive monitor, and LEDs 112 are used for user feedback to indicate such items as Bluetooth radio operation, and to indicate when different monitor operations have occurred, such as feedback for button presses. A 32 Mhz crystal/oscillator 109 is used for powering the SOC at full speed, and a 32.768 kHz crystal/oscillator 110 is used to power the SOC in the lowest power mode in order to minimize battery discharge. A flash/debug connector 119 is used for the dual purpose of allowing the SOC 101 to have its program, which resides in internal non-volatile Flash memory, be upgraded after being shipped, as well as a connection point for debugging SOC operation during development or in the field if a problem occurs and needs to be debugged or fixed.

There are multiple reasons for using low power radios on the hive monitor 11, rather than higher power devices such as cellular or satellite phones or modems. First, there is at least conflicting evidence that RF radiation is at least a contributing factor to the phenomenon referred to as Colony Collapse Disorder (CCD) which has had devastating effects on bee populations over the past several years. But there is more data that indicates that higher power RF communications (such as a cell phone) in direct proximity to a hive (for as little as 10 minutes of operation per day) has an effect on the navigational skills of worker bees which leads to the worker bees leaving the hive, and not returning. If this continues the hive will not survive. So minimization of RF generation in close proximity to the actual hive is desirable (as opposed to placing a cell phone or cellular modem on each hive). And at nominal communication speeds and amounts of data, this communications link between the monitor and collector should only be active for about 1 second per day for each monitor. Secondly, use of a low power radio on an individual monitor/hive is a much less expensive option than putting a dedicated cell phone or satellite phone on each hive. Thirdly, the hive monitor 11 is expected to typically run from battery power only, so all power usage is critical to battery life. Use of a lower power communications device in the monitor 11 significantly increases the battery life with respect to how long it would last if it had to support a cell phone itself.

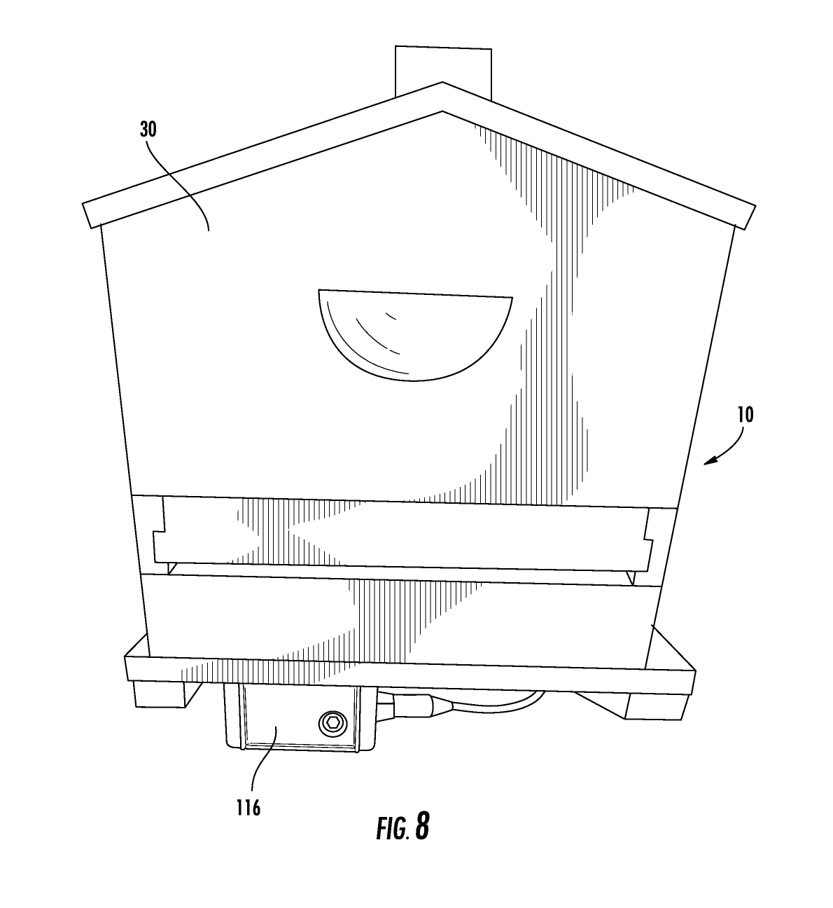

The hive monitors 11 may have a wide variety of parameters that may be measured and logged such as weight, temperature, humidity, tilt angles, acoustic information, GPS location, physical orientation, wind speed & direction, etc. However, the most commonly expected hardware sensor for a hive is an overall weight sensor or load cell. In one embodiment, the load cell is connected to an H-frame on which the hive 30 is placed (FIG. 8). To get a starting weight, there are multiple options. In any case, the hive monitor 11 is mounted below the hive 30, typically to the H-frame if available, and accessible from one side of the hive. The front of the hive monitor has space for a nameplate with monitor model and serial number in both human readable as well as bar-coded format. Additionally, there is a single push button and two LEDs, one blue and one orange). The two LEDs are provided on the front as indications to the user for operational and debug purposes. One LED may be orange and used for a variety of indications. The other LED may be blue and is turned on while the Bluetooth radio is enabled.

A first step in the initialization process is to determine a starting weight and initial tilt angles. The weight may be initialized without the hive, or after the hive has been placed. In either case, the weight gain from this initialization point should represent what has been brought back into the hive by the bees. To set this starting weight, the push button on the front of the hive monitor 11 is pressed and held for 5 to 10 seconds, and then released. This will establish an initial weight of zero. Any additions or subtractions from the weight at this point will show up as variances from zero. An alarm will be generated to indicate that a zeroing of weight was done at this time. The same button press to zero the weight is also used to define the initial angles in an embodiment wherein an accelerometer is an available sensor on the monitor 11. An accelerometer is used to read tilt angles in two horizontal directions. Once the initial tilt angles are determined, a threshold angle may be defined such that movement beyond this initial angle plus threshold will generate an alarm condition. This zeroing/initialization function may also be performed with the portable configuration device 16 as a simple function while it is in communication with the hive monitor 11.

While the button is pressed from 0 to 5 seconds the orange LED will be off, from 5 to 10 seconds the orange LED will be on solid indicating a release will cause the weight to be zeroed, from 10 to 30 seconds the LED will blink for 0.1 second every two-second interval to indicate the button is still pressed but will do nothing if it is released, and after the button has been pressed for 30 seconds the orange LED will start blinking by turning on for ¼ second and off for ¼ second. This will continue until the button is released, at which time the configuration parameters will be reset to factory defaults, as described below.

Although there are a number of additional initialization settings that can be done, this is sufficient setup for a system, and may be done without the portable configuration device 16. The next step is for the data collector 14 to register the hive monitor 11, if a collector 14 is to be used, otherwise data would need to be manually read by the portable configuration device 16. And at that point, the monitoring system 10 should be able to run.

In another embodiment of the monitoring system, a portable configuration device 16 is used to configure each individual hive monitor with program configuration settings as well as informational parameters with which the specific hive the monitor was associated. These monitor configuration parameters would include, but not be limited to, such things as present time and date, length of time between power ups, which measurement parameters are to be read (i.e, overall weight, temperature, humidity, GPS location (if GPS receiver is integral to the monitor), acoustic information, tilt sensor, feeder weight, etc.), which measurement parameters are to be logged and reported, length of time between different types of measurement parameter readings, which measurement parameters should be evaluated for alarm conditions, alarm threshold values, etc. Hive specific informational parameters would include, but not be limited to, things such as hive monitor model and serial number, GPS location (if GPS receiver is not integral to the monitor), overall hive identifier, individual hive components installed, etc.

Enabling a hive monitor 11 to talk to a portable configuration device (PCD 16) 16 over Bluetooth begins by pairing the PCD 16 and the hive monitor. For this reason it may be useful to know the monitor serial number, since this is what is used to identify the monitor when the PCD 16 is pairing. The hive monitor serial number can be entered manually into the PCD 16, or the PCD 16 may use its camera, if this capability exists in the particular PCD 16, to read the bar code from the nameplate of the front of the monitor, which has the serial number embedded in it. Once pairing is completed between the PCD 16 and the hive monitor 11, this pairing process is no longer required for future communications.

Keeping track of hive identification independent of the monitor 11 allows performance of individual hives to be evaluated if they are deployed from one location to another as in a commercial operation. This type of movement could easily have one hive on different monitors at different locations, so hive identification is important to know which hives are superior performers versus other under-performing hives, which could indicate hive problems. And keeping track of individual hive components (lower deep, upper deep, supers, hive feeders, etc.) gives the ability to assign tare weight values to the different components to obtain better estimates of honey production. Also, when components are added or removed, there may be large weight changes. Large weight changes would typically set off one or more alarms, but the PCD 16 can be used to log events or modify the component list which may indicate reasons for weight changes.

In one embodiment, the individual hives and individual components may either be entered by hand on the PCD 16 or by use of a bar-code identification. The monitor model number and serial number are on the monitor nameplate in both human readable and bar-coded forms. Additionally, the different components used in the hive could have bar-codes affixed to the components for reading by the PCD 16, or by entry of predefined component identifications by hand. The type of hand entry may be by a variety of means such as free text entry, dropdown selection lists, selectable check off boxes for included components, or any number of other methodologies.

Use of an automatic hive component identifying mechanism is also contemplated. This could be implemented by simply adding wiring to each component in the same general location such that one component could be plugged into the next component, and it to the next, and so on. At that point, an element would be used on each component to identify the component itself. For example, some number of lines in the interconnected cable with each component grounding a line to indicate its presence. Or a smaller number of lines may be used as a serial bus, and then each component would have a small amount of non-volatile memory (such as EEPROM, Flash, etc.) that had been programmed to identify the component. Then at some predefined time schedule, the hive monitor 11 would do a query on the serial communications line to see what hive components are present. This could then self-populate the component list that would then be available to be read by the PCD 16 or data collector 14 and eventually getting up to the CDR 15.

In addition to downloading information to the hive monitor 11, the PCD 16 may also request information from the hive monitor, such as information to identify the specific monitor, which could later be used to load into the data collector 14 that will be reading this monitor, so that the specific hive monitor 11 will be allowed to register with that specific data collector 14. In one embodiment, this monitor specific identification is a MAC address.

When the portable configuration device 16 is used for initialization, the hive monitor 11 must be turned on and listening to the appropriate communications link in order to respond. This is accomplished in the preferred implementation by use of the button on the front of the monitor 11. The button is pressed and held for about 1 to 2 seconds and then released. This causes the hive monitor 11 to wake up, turn on the low power radio (Bluetooth) and the blue LED, then wait to hear from another device, for example the portable configuration device 16. Once the monitor 11 and the PCD 16 have been paired with each other, the PCD 16 will then download the new monitor configuration parameters, hive specific parameters, and upload the MAC address. When the communications are finished, the hive monitor 11 will go back to sleep and both LEDs will be turned off.

When the hive monitors 11, 12, 13, 18, 19, 20 are moved to different hives, it may be necessary to reset the configuration parameters to get the unit back to a known state. This may be done with the button on the front of each hive monitor. In order to reset the configuration, the push button should be pressed and held for a period greater than 30 seconds. After this time, the configuration parameters will be reset to the factory default values. The orange LED is used to give feedback to the user to indicate that the button has been pressed for the required period of time. The indication that the button has been held for a sufficient period of time is when the orange LED starts to blink on and off for ¼ second in each state. Once this occurs, whenever the button is released, the configuration will be reset. In addition to the resetting of the configuration parameters, the previously logged information will be discarded (or marked invalid), and an alarm flag will be set to indicate that the monitor has been reset. This function may also be done by the PCD 16 as a simple function while it is in communications with the hive monitor 11.

Once the hive monitor 11 has been initialized, it is then registered with a data collector 14, assuming that it is to be read by a collector. In one embodiment there are three different modes in which the data collector 14 will register a new hive monitor 11, as will be described in detail below. Assuming that the data collector 14 is ready to register this new monitor 11, the process begins by pressing the button on the monitor two times in quick succession (double-click). This will wake up the hive monitor 11 and power on the low power IEEE 802.15.4 radio communications. The monitor 11 will wait for a beacon signal from a data collector 14 and will then respond with a request to be registered. If the data collector 14 allows the hive monitor to be registered, then a number of pieces of information may be passed between the monitor 11 and the collector 14. Passing of data from monitor 11 to the collector 14 may include monitor serial number, MAC ID number, monitor GPS location, hive identification, hive component list, etc. Passing of data from the data collector 14 to the monitor 11 may include present date and time, configuration quantity modifications, data collector identification, etc.

This implementation contemplates some cases where the lack of a data collector 14 in the system would require the portable configuration device 16 to perform the collector function. In this case the same process would occur, except instead of double clicking the monitor button, it should only be momentarily pressed to engage low power RF (Bluetooth), and once in communication with the PCD 16, the PCD 16 would then initiate the setup, receiving monitor data, and passing down “collector” information. The main difference would be that the data collector 14 identifier would include a flag to indicate that the collector is in fact a PCD 16. This is important because the monitor needs to know that there will not be a data collector 14 available to receive data. So when logged data or alarm events would normally be passed up to the data collector 14, the monitor will have to wait until a PCD 16 manually requests the information.

In normal operation, a hive monitor 11 will spend most of its time in a sleep mode to conserve limited battery power. At a regular interval the microprocessor will wake up and perform a limited number of tasks which include updating the real time clock by the amount of time that the part was asleep, determine what monitoring functionalities should be done at this interval, perform only the measurements that are required, check for any alarm conditions that were detected from the measurements made, and immediately transmit back a request to report any alarm conditions which were enabled and were found to be failing. In one example, the implementation uses a power up time of about 8 seconds. This time can be configured to be faster or slower which causes a tradeoff of response time versus battery life, but this allows the user to make the tradeoff decision.

Assuming that the monitor power up time is configured to 8 seconds, this implementation has the various measurement functionalities being configured to be performed after some number of these intervals. However, embodiments also contemplate determination of the time to perform the functions by keeping a timer from the last time the function was performed, or by setting some predefined real-time interval so when the monitor's real time exceeds a predefined interval the function will be performed again, or any number of other means for determination of when readings are to be taken. When the specific measurements are made, the results are time-stamped and logged if so configured. Some measurements, such as a tilt sensor, may only be desired to be known if it exceeds some threshold value, indicating a significant problem, so there may be no need for logging this data, but there would be reason to send in an alarm condition.

As stated above, a variety of alarm conditions may occur, and if so configured, the hive monitor 11 will make a call in to the data collector 14 to report the occurrence of an alarm condition. The data collector 14 will then query the monitor as to the alarm condition and any parameters that may be included with the alarm. If an alarm is configured in the data collector 14 to immediately report to the CDR 15 (and if the collector 14 has a communications path to the database available), then the alarm will also be passed up to the CDR 15. There are a number of different alarms, and within the CDR program, each alarm may be configured to generate a variety of responses, which could include doing nothing, sending a SMS text messages to the user, initiation of some external equipment, such as auxiliary heat or ventilation, or other equipment specific to resolving the specific problem causing the alarm.

Assuming that there are no alarm conditions that make the hive monitor 11 call in, the time-stamped and logged data is stored in non-volatile Flash memory within the monitor. Each time the monitor makes a subsequent set of data measurements, they are also time-stamped and logged in non-volatile memory. This non-volatile memory may be battery backed RAM, EEPROM, or a number of other non-volatile technologies, and in one implementation is Flash memory. Then over a longer periodic time frame, about 12 hours in one embodiment, the data collector 14 queries the hive monitor 11 to upload its logged data.

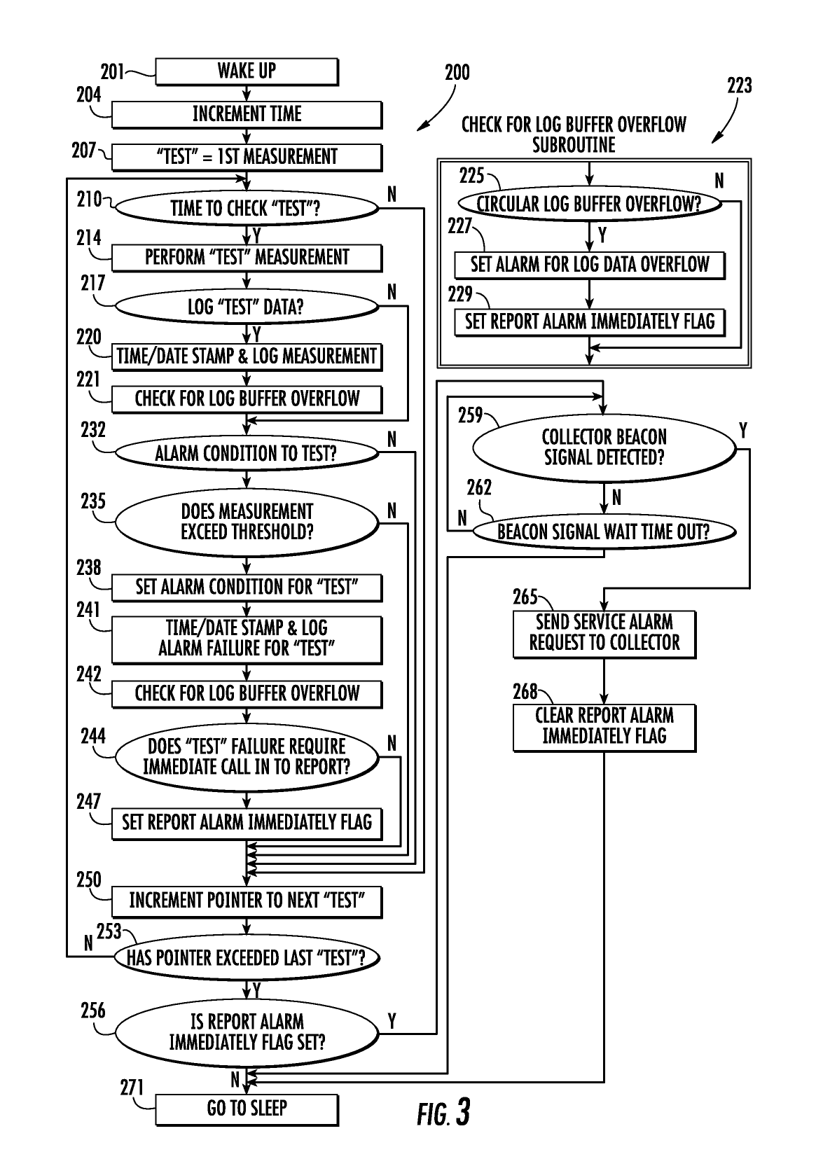

FIG. 3 shows a flowchart of the general operation of the hive monitor 11 and is generally designated at 200. The hive monitor wakes up 201. Monitor power up time is typically 8 seconds. The monitor 11 then increments its real time by the number of seconds in the monitor power up time 204. Then the monitor 11 determines which measurements are to be made at this point in time. Each measurement type is referred to as the “Test”. The first measurement is selected and set as the “Test” in 207. In the next step, it is checked to see if it is time to perform the present “Test” measurement 210. If not, then code flow branches to increment to the next “Test” 250.

If the “Test” is to be performed, then the measurement is made in 214, and a check is made to see if the measurement needs to be logged 217. If not, then code flow branches to 232 to check on alarm testing, but if the measurement is to be logged, then the measurement is time-stamped and logged in to the log buffer 220. The log buffer is typically a circular buffer in the hive monitor 11, so a check is done to see if the circular buffer has wrapped over log data that has not been reported 221. This check is shown in FIG. 3 as a subroutine 223 to check for log buffer overflow. Within the routine, a check is first made to see if an overflow condition has occurred 225. If the log buffer has not overflowed, then code flow branches out of the subroutine, but if the buffer has overflowed, then an alarm condition is set for a log buffer overflow condition 227, and the report alarm immediately flag is set 229. Then the code exits the subroutine 223.

Once the subroutine 223 has been exited, a check is done to see if the “Test” measurement has an alarm condition for which it is to be tested 232. If there is not an alarm condition, then code flow branches to increment to the next “Test” 250. If there is an alarm to test for, the measurement is tested to see if it fails the test condition 235. If there is no alarm condition failure, then code flow again branches to increment to the next “Test” 250. If there is an alarm test failure, then there is an alarm condition failure flag set for this particular “Test” 238, and the alarm is time-stamped and logged in to the log buffer 241. Again, a check is made to insure that the log buffer has not overflowed 242, and to set the appropriate flags if it has as performed by the subroutine 223. Once the alarm has been logged, a check is made to determine if the “Test” failure requires an immediate call in to report 244. If an immediate call in is not required, then code branches to increment to the next “Test” 250. If an immediate call in is required, then the report alarm immediately flag is set 247, and then code falls through to increment to the next “Test” 250. The code flow increments to the next “Test” 250 and then checks to see if the next “Test” is a valid test 253, or if the code has incremented beyond the final “Test”. If the newly incremented to “Test” is still a valid “Test”, the code flow branches back up to recheck for this next “Test” 210. However, if the new “Test” is not a valid test, then the code has processed all the possible “Tests” and it is ready to potentially report up to the data collector 14.

The system checks to see if the report alarm immediately flag is set 256. If it is not, then the code falls through to 271 where it goes into the low power mode waiting for the next power up time (i.e., it goes to sleep). If however, the flag is set, then the code branches to 259 where the monitor waits to hear a beacon signal from the collector 14. The monitor 11 cycles between 259 and 262 waiting for either a beacon signal to be heard in 259, and then branches to 265, or it times out in 262 and branches back to 271 to go to sleep. If the beacon is heard in 259, then the monitor will send a service alarm request 265 up to the collector, and clear the report alarm immediately flag 268. It is then the responsibility of the collector to come back and query the monitor to determine the alarm condition that was triggered.

If the operation times out while waiting for the beacon signal, the next time the monitor powers up, the report alarm immediately flag will still be set from the previous period, and the monitor 11 will attempt to report the alarm, even if no alarm actually occurred during that power up sequence.

When the next monitor power up time occurs, the whole process 200 starts over.

Although the logged data is typically automatically uploaded from the hive monitor 11, preferably twice per day, the monitor in fact stores a much larger amount of logged data in its non-volatile memory. In one embodiment, the hive monitor 11 would store approximately 3 month's worth of data. This is important for the use case where there is no data collector 14, but the hive monitors are being read directly by a portable configuration device 16. This reading will be a manual operation and there may be reasons that it is not possible to read the monitors for an extended period of time, so having this large amount of logged data storage is important. Additionally, there may be cases where the data was previously read and may have been lost or deleted before being uploaded to the CDR 15.

It is also contemplated that hive monitors 11 may be used for a period of time, and then relocated and used with a different hive and collector. In that case the monitor will need to be initialized again by a portable configuration device 16. In this initialization, in addition to the normal items described earlier, the monitor 11 should be given a command to clear the old log data, which is no longer applicable to the hive to which the monitor is now paired. This clearing of data may also be achieved by pressing and holding the button on the monitor for a period in excess of 30 seconds. This will clear the logged data but also resets the configuration values back to factory defaults.

The data collector 14 is primarily responsible for reading the logged data and alarm conditions from all of the hive monitors 11, 12, 13, 18,19, 20 and reporting them back to the CDR 15. However, there are a number of other functions that the data collector 14 must perform. These functions include possible acceptance of configuration information to the data collector 14 from the portable configuration device 16 (with such exemplary items as downloading Network Name and Password for use in a WiFi configuration, as well as GPS location coordinates if a GPS receiver is not integral to the data collector, etc.), registration of new hive monitors, possible passing of logged data and alarm conditions either to the central database repository 15 via cellular modem, satellite modem, or WiFi connections, possible passing of logged data and alarm conditions to a PCD 16, and passing along hive monitor specific configuration to hive monitors with which it communicates.

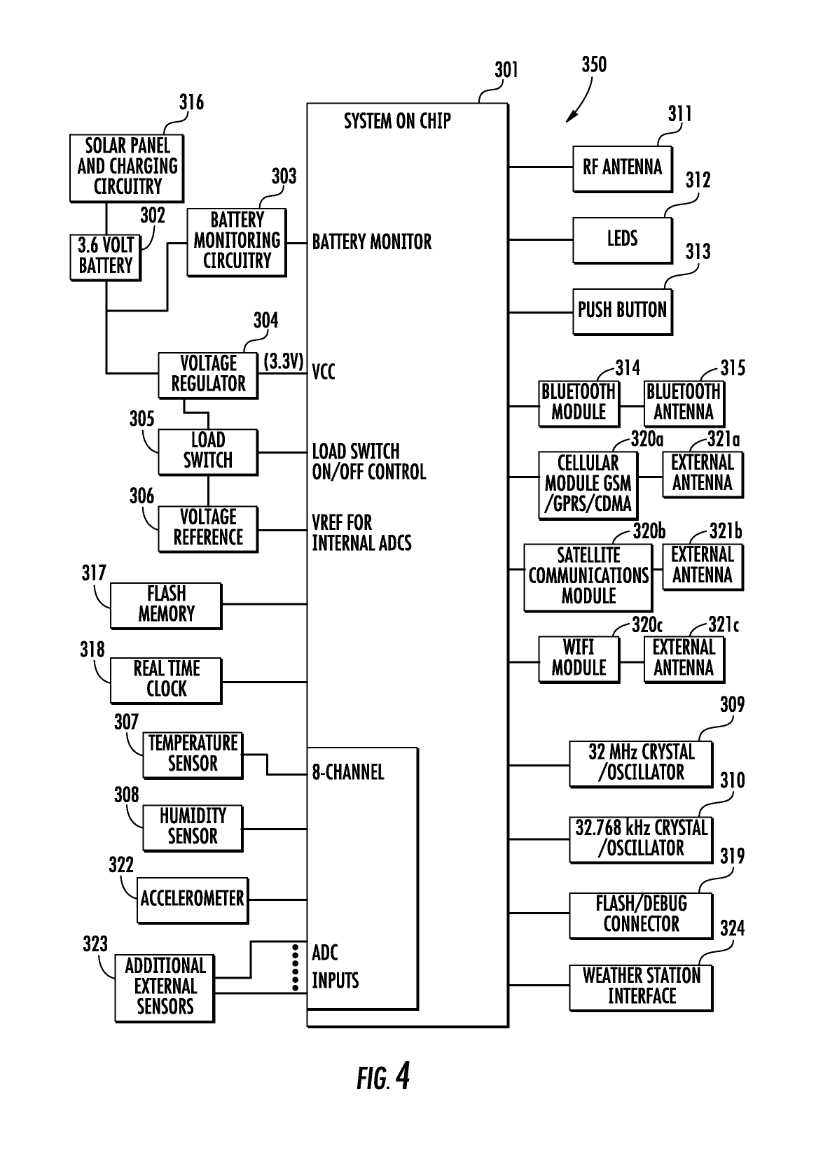

FIG. 4 is a block diagram showing functional components of an embodiment of a data collector 14 for use in apiary monitoring system. As shown in FIG. 4, a collector 14 preferably includes the main system on chip (SOC) controller 301 around which the other parts are built. A 3.6 volt rechargeable battery 302 is used as the primary power source, and a battery monitoring circuit 303 is used to pass a signal on to the SOC 301 to determine when the battery is about depleted. An optional solar panel and charging circuitry 316 may be used to recharge the collector battery 302 since the collector will be operational for a much larger percentage of the time as compared to a hive monitor 11, and use of the higher power radios to gain access to the CDR 15 will use more energy than the low power RF signals. A 3.3 volt voltage regulator 304 converts the battery voltage to a lower voltage of 3.3V for use as the supply voltage for most of the other components. A voltage reference 306 is used to generate a reference voltage for the internal analog to digital converters (ADCs). Board level external temperature sensor 307, humidity sensor 308, and accelerometer 322 also feed into inputs of the internal ADCs on the SOC 301. Capabilities are present to allow additional external sensors 323 to also be input, which may include but not be limited to measurement devices such as microphones, additional temperature sensors, or other desired inputs. Additionally, a weather station interface 324 is planned in order to be able to record general weather information valid for the apiary as a whole, rather than for that of each individual monitor since the collector will typically be in close proximity to the monitors.

An external load switch 305 is controlled by the SOC 301 and is used to disable the circuitry that allows for operational measurements. This is to reduce power drain to an absolute minimum for extended battery life. An antenna 311 for low power RF (IEEE 802.15.4) communications to all hive monitors is included, as well as a low power RF module (Bluetooth) 314 and antenna for Bluetooth communications 315 which will be used to communicate with the portable configuration device 16. A push button 313 is available for direct user input to force a variety of operations by the data collector 14, and LEDs 312 are used for user feedback to indicate such items as Bluetooth radio operation, and to indicate when different collector operations have occurred (i.e., feedback for button presses). Non-volatile memory 313 such as Flash memory is used to store all of the logged data readings as read from the various hive monitors until the information is passed on to the CDR 15. A real time clock module 318 is used for keeping track of time. This could be implemented internal to the SOC 301, but in this implementation it is implemented as an external part to do this function.

The apiary monitoring system 10 contemplates a number of different communication paths to move the logged data and other information out of the data collector 14. FIG. 4 shows several alternatives for the communications path, but this does not preclude the possible use of other technologies. In one embodiment, the communications path would be via cellular communications module 320a which would be able to talk GSM, GPRS or CDMA, and use an external antenna 321a. In another embodiment, a satellite communications module 320b and an external antenna 321b could be used. A third embodiment would have a WiFi module 320c and an external antenna 321c. As described above, the portable configuration device 16 can be used to manually read the data collector 14 and then upload the data manually also to the CDR 15. This embodiment would not require any of the 320x modules or 321x antennas.

A 32 Mhz crystal/oscillator 309 is used for powering the SOC 301 at full speed, and a 32.768 kHz crystal/oscillator 310 is used to power the SOC 301 in the lowest power mode in order to minimize battery discharge. Finally, the flash/debug connector 319 is used for the dual purpose of allowing the SOC 301 to have its program, which resides in internal non-volatile flash memory, upgraded after being shipped, as well as a connection point for debugging SOC 301 operation during development or in the field if a problem occurs and needs to be debugged.

Upon installation of an apiary monitoring system, including monitors and a collector, some amount of initialization may be required. However, mandatory initialization can be kept to a minimum for simplicity purposes. Any configuration that must be done, may be done with at least a set of default data at the factory when the unit is built for a customer. This would include, but not be limited to, data collector identification number, use of solar recharger or not, initial date and time being set, the time between automatic calls back to the central database repository, as long as a direct communications link is available to the database, which type of communications link is to be used to report back to the central database repository (cellular, satellite, WiFi, Portable configuration device, etc.), any communications link specific items (phone numbers, type of cellular (GSM, GPRS, CDMA), SIM card, etc.), which alarms should be reported immediately and which should be reported with normal data, etc.

Some of these parameters may be modified if desired upon initialization, but the one item that will be required to be set at initialization is a network name and password for use in a WiFi configuration. GPS coordinates may also be set by the Portable configuration device if the data collector 14 does not have an integral GPS receiver. Hive monitor specific identifiers may be loaded to the collector for use with one of the collector modes of monitor acceptance into a LAN. And if the data collector 14 had been previously used and was now moved to another location for use with a different set of hive monitors, then the list of monitors in the LAN needs to be reset, which may be done by the PCD 16 or via button press on the data collector 14. Another configuration item would be the amount of time that the collector would allow monitors to be accepted into the LAN (default is 30 minutes). This configurable acceptance period is used by another one of the collector modes of monitor acceptance into the LAN, which is described below.

Use of a PCD 16 with a data collector 14 requires the collector and PCD 16 to be paired. This is done in substantially the same manner as was done for the hive monitor 11. Again, the collector serial number is available in both human readable and bar code formats on the nameplate of the collector, and this is used for identification purposes during the pairing process.

Once any Data Collector configuration that needs to be done is done, then the data collector 14 may start accepting hive monitors into its LAN. This process is triggered by a button press sequence on the data collector 14. One embodiment includes three different “modes” for monitor acceptance into the LAN. A first mode is a default mode; however, the mode may be changed by the PCD 16. The first mode is the easiest to allow monitors to join. In this mode, any monitor which is “heard” by a collector and requests to join the LAN is accepted. This is the default acceptance mode, and would be used in applications where there is only a single collector that is expected to handle all monitors.

A second mode adds some limitations on LAN acceptance. In the second mode, the collector is configured to allow acceptance of any monitor that is “heard” and requests to join the LAN, but only for a limited time. This time is configurable (default is 30 minutes) and the timer is initiated by a command from the portable configuration device 16. This allows acceptance of newly installed monitors typically in areas where there are multiple collectors, and where a new monitor is desired to be “seen” by a specific collector.

A third mode is very specific on LAN acceptance. This mode requires that a list of acceptable monitor ID numbers be given to the data collector 14, and that only those ID numbers will be allowed to join the network. The list of acceptable monitors is limited, but the timing for their acceptance is not limited (similar to the first mode). This might be done for commercial operations where hives are moved from one location to another. In this case it may be desirable to have a predefined list of acceptable monitors so that when a group is moved from one location to another, the collector can easily rebuild the LAN group from the predefined list of expected monitors.

Once in operation, the purpose of the data collector 14 is to collect logged information and alarm calls from the monitors 11, 12, 13, 18, 19, 20, and pass them back up to the CDR 15. The process begins with the collector and all the monitors waking up at the same general time. The collector then sends out a beacon signal to synchronize all the monitors to the same reference time and which may be used as a reference point for the next “wake up” Immediately following the beacon signal there is an “active period”, typically a short fixed period such as 100 milliseconds, when communications may take place between devices. After this active period, all devices, monitors and collector, typically power back down.

Normal communications between the collector and monitor are typically initiated by the monitor when it is trying to get registered by a collector into a LAN, or if it detects an alarm condition. Communications initiated by the collector 14 typically occur when it is time to obtain the monitor's logged data, or if there are specific reads or writes of information to the monitor as requested by the central database repository 15 or PCD 16.

Within the data collector 14 there are three separate communications request lists: Scheduled Reading list, On Demand Reading list, and Alarm Reading list. Once the data collector 14 sends out a beacon signal and is ready to communicate, it checks the three lists to see what request should be made first. The highest priority list is the Alarm Reading list. If there are any requests in the Alarm Reading list, those will be read first. Only if the Alarm Reading list is completely empty, then the On Demand Reading list will be checked (second priority). And if both the Alarm Reading and On Demand Reading lists are empty, then the Scheduled Readings list will be serviced.

The highest priority normal monitor/collector communication is when an alarm condition is detected by a monitor. At that point the next time the unit powers up and a beacon signal is transmitted by the collector, the monitor sends up a request for the collector to read an alarm condition. This request will be placed at the end of the queue in the Alarm Readings list. The next time the collector is available to communicate, it will first check the Alarm Reading list, and when this request makes it to the top of this list, the collector will make a request to the monitor that reported the alarm to obtain information on the reported alarm condition. The alarm conditions as read from the monitor will be logged in the collector memory, the request will be removed from the Alarm Reading list, the alarm condition will be checked to see if it should be reported immediately, and if so a flag will be set indicating the need to upload an alarm condition and the data collector 14 will establish a communications link to the central database repository 15, if an appropriate communications pathway is available in the collector. The alarm condition will be uploaded to the database, and the collector will clear its indication that there is an alarm condition to be uploaded.

Not all alarm conditions need to be immediately uploaded to the CDR 15. Typically, measurement parameters with allowable tolerance values which have failed would be passed up immediately. But other alarm conditions are simply to report informational items such as changing of a hive component, changing of a GPS coordinate location, modification of a measurement tolerance value, etc.

In the case where there is not a communications pathway available for the data collector 14 to automatically report the alarm condition, such as when the collector is to be manually read by a portable configuration device 16, the collector 14 will log the alarm condition and set the indication that an alarm condition needs to be reported. When a PCD 16 is available to read the collector 14, the communication session is initiated by pressing the button on the collector to initiate a low power RF (Bluetooth) communications session, and the PCD 16 will then request any archived alarm conditions. When this is completed, the collector will clear its indication that there are any alarm conditions to be uploaded.

The second highest priority normal monitor/collector communication is when a particular request is made to write or read something to or from a monitor. This could come from a request initiated by the central database repository 15 or by a portable configuration device 16. This might occur for reasons such as changing configuration parameters in one or more monitors, or to request some archived data in a monitor that is not normally passed back to the collector such as battery status or remaining capacity, alarm condition values, etc. The original request is queued up in the location from which it is generated, CDR 15 or PCD 16, until the specific collector associated with the desired monitor either calls in, in the case of the CDR 15, or a low power RF link is established in the case of a PCD 16. At that point the request is passed directly to the collector. Once the request is received by the collector, the request is placed at the end of the On Demand Reading list. When the next beacon signal is generated by the collector, the collector will check if there are any requests in the Alarm Request list. If there are none in that list, it will check the On Demand list. It will process each of the entries in the On Demand list as long as the Alarm list is empty, and when this specific request gets to the top of the list, the specific request will be executed. If there was any response received from the monitor, such as archived data, that is expected to be passed back to the requesting entity, CDR 15 or PCD 16, then this information is buffered in the collector until it is able to establish the appropriate communications link, at which time the requested information will be passed back.

When it is time for the data collector 14 to get readings from all of the monitors, the collector fills the Scheduled Readings list with all monitors that it is presently servicing and needs to read. The Scheduled Reading list is the lowest priority normal monitor/collector communications. When the units power up, a beacon signal is transmitted, then a check is made to the Alarm Reading list. If it is empty a check is done to the On Demand Reading list. If it is empty, then the collector services the Scheduled Readings list. The collector requests a set of logged data from a specific monitor (first one in the list). These are typically all the logged readings since the last reading of the monitor. Returned monitor readings are then archived in the collector's memory, and the collector and monitor then power down. The next time all the hive monitors power up, the beacon is transmitted, and a request for logged data is made to the next monitor in the list. This is repeated until all monitors have been read. Once all the monitors have been read from the Scheduled Readings list, the data collector 14 sets an indication that a complete set of logged monitor data is available, and then establishes a communications link to the central database repository 15 if an appropriate communications pathway is available in the collector. The complete set of data for the reading is uploaded to the database, and the collector clears its indication that there is a set of data to be uploaded.

Again, in the case where there is not a communications pathway available for the data collector 14 to automatically upload its data, such as when the collector is to be manually read by a portable configuration device 16, the collector will then read and store multiple complete sets of logged monitor data, along with an indication that one or more sets of logged monitor data needs to be read. When a PCD 16 is available to read the collector, the communication session is initiated by pressing the button on the collector to initiate a low power RF (Bluetooth) communications session. The PCD 16 will then request the archived sets of logged monitor data. When this is completed, the collector will clear its indication that there are any sets of data to be uploaded.

As mentioned above, a single button press on the data collector 14 for 1 or 2 seconds and then released will cause the collector to enable the Bluetooth communications so the collector may communicate with a portable configuration device 16. Pressing the button for 5 to 10 seconds and then releasing will enable the LAN acceptance if the collector is configured to only allow acceptance for a specified time period. Pressing the button for a period in excess of 30 seconds will reset the collector, clearing the LAN device list, resetting configuration values back to factory defaults—with the exception of WiFi Network name and password, and clearing any archived information. Finally, pressing the button twice in quick succession (double-click) will cause the collector to call into the CDR 15 so that any information accumulated to date may be uploaded, and any request information from the CDR may be passed down to the collector.

Operation of the orange and blue LEDs on the data collector 14 may work in the same fashion as on the monitor. The blue LED on indicates operation of the Bluetooth radio. Operation of the orange LED indicates the different operations caused by the push button. With the button pressed from 0 to 5 seconds the orange LED will be off, from 5 to 10 seconds the orange LED will be on solid (indicating conditional LAN acceptance mode), from 10 to 30 seconds the LED will blink for 0.1 second every two-second interval (to indicate the button is still pressed) but will do nothing if it is released, and after the button has been pressed for 30 seconds the orange LED will start blinking by turning on for ¼ second and off for ¼ second. This will continue until the button is released, at which time the collector will be reset, as described above.

In one embodiment, the portable configuration device 16 is a device that is able to communicate with either hive monitors 11, 12, 13, 18, 19, 20 or data collector 14. In this embodiment this is done via low powered RF (Bluetooth communications). There is also a communications link available from the device to the CDR 15, although it is not required for minimal implementation of a system.

It is contemplated that the PCD 16 could be a custom designed piece of electronics, but one embodiment could be a smart phone, a tablet computer, a laptop computer, or some portable piece of electronics which could be programmed to perform the required functionality.

In use, the PCD 16 could be used to simply read one or more monitors manually, similar to the functionality normally handled by the data collector 14. This would be done by physically going to each hive monitor, pressing the button momentarily to allow a Bluetooth communication session to be established, then read the alarm conditions and logged monitor data from that specific monitor, and resetting the indications of what had been read from the meter. Then a user interface on the PCD 16 could display the data that was just read, along with previous readings stored locally on the device. Depending on the complexity of the analysis programming available in the device, additional analysis could be done if the device also served as the storage location for the archival information on the monitors being read. The only functionality that this PCD 16 would have to have would be the low power RF (Bluetooth) communications, and programmability to implement the desired functions.

In addition to the ability to read the monitors manually, the PCD 16 may also be used when a hive monitor is initialized. By default the hive monitor identification number is available when logged data is passed back, but additional information is available to be used to identify more precisely what is included in the hive. Although not required, a camera on the PCD 16 is useful for reading bar coded information more quickly than entering the same information manually. This information may include, but not be limited to, Hive identification, hive components included, which measurement capabilities are available with this monitor, etc.

In another embodiment, an integral GPS receiver is contemplated in the hive monitor 11 or the data collector 14, such that the GPS location information is always available. But for a lower power and less expensive system, the GPS is integral to the PCD 16, and has the GPS coordinates being passed to the monitor or collector by the PCD 16. In this embodiment, the hive specific information would be entered, either manually or by bar code, into the PCD 16. The button on the hive monitor 11 would be momentarily pressed to establish a low power RF (Bluetooth) connection between the monitor and portable configuration device 16. The hive specific information would be written from the configuration tool to the monitor, from which it may be queried by the collector.

During initialization, any informational data available in the hive monitor is passed up to the data collector, and then on to the CDR 15. After that time, if any informational data is modified in a monitor, then the monitor would log an alarm condition and issue a request for the collector to service the alarm. This informational alarm data would not typically be uploaded to the CDR 15 immediately, but rather during the Scheduled Readings.

Additional configuration changes to individual hive monitors 11, 12, 13, 18, 19, 20 may be performed in the field. This could be a hardware change, such as adding or removing a measurement device (a temperature or humidity sensor for example) on the hive, or changing the components on a hive (adding or removing deeps, supers, feeders, etc.). Configuration changes could also be programmatically changed, such as changing a temperature threshold or changing the amount of weight change required to trigger an alarm condition. One additional type of informational alarm that is available via the PCD 16 is the addition of a comment. This may be a selection from a number of predefined comments, or free text entry that is passed from the configuration device to the monitor. This will be time stamped and archived for later analysis. This may be useful for interpretation of the data from a monitor, especially if there are some unusual circumstances that should be known. Again, any configuration changes made by the PCD 16 after the monitor has been initialized will cause the monitor to log an alarm condition and the associated condition that changed. Processing of these alarm conditions up to the data collector 14 would occur in the same manner as informational changes in order for them to eventually be passed up to the CDR 15.

In this embodiment, if a connection was available to the Internet (via WiFi or cellular phone or any other means), then it would be possible for the PCD 16 to make connection with the central database repository 15. Logged monitor information could be uploaded to the CDR 15, and additional processing may be available, as well as the ability to share information with other users and researchers, and view the results from anywhere with an Internet browser.

Availability of the internet connection to the PCD 16 may change how the device is used when the configuration device is in a communication session with a hive monitor. If the configuration device has an internet connection while in communication with the monitor, the configuration device may be used simply as a conduit from the CDR 15 to the monitor. If however, the configuration device 16 is only able to obtain internet connectivity when there are no monitor communications that are open, then the configuration device must buffer all the requests from the CDR 15 until it is in contact with the specific monitor for which the request was made. Then once communications is established with the specific monitor, the requested communication will be executed, and if there were any responses from the monitor, the responses must also be buffered by the configuration device until it is again in communications with the CDR 15, when it may then pass the data back.

A slightly more complex embodiment of the apiary monitoring system 10 would be to have multiple hive monitors being serviced by a data collector 14, which did not have a direct communications path to the CDR 15. In this case, the data collector 14 would operate normally with the exception that it would be unable to automatically report anything directly back to the CDR 15. The collector would have to wait for the portable configuration device 16 to establish a low power RF (Bluetooth) communications link. This would be done by physically going to the data collector 14, pressing the button momentarily to allow a Bluetooth communication session to be established. If the configuration device 16 had a direct connection to the Internet, then the configuration device would simply act as a conduit for the normal communications between the collector 14 and the CDR 15. If however, the configuration device 16 is only able to obtain Internet connectivity when there are no collector communications that are open, then the configuration device must buffer all the requests from the CDR 15 until it is in contact with the specific collector for which the request was made. Then once communications are established with the specific collector, the requested communication will be executed. This will most likely be requests for one or more monitors which will have to be added to the communications lists within the collector to be serviced when the collector establishes communications with the required monitors. Additionally, while in communication with the collector, the PCD 16 will also read any information that would normally have been expected to be passed up to the CDR 15. The configuration device will buffer the information, and will pass it back up to the CDR 15 the next time it is in a communication session with the database.

Again, similar to the first simple system, if the PCD 16 has no communications path available to establish a communication link with the CDR 15, a user interface on the PCD 16 may be used to display the data for the multiple monitors that were just read through the collector, along with previous readings stored locally on the device. Depending on the complexity of the analysis programming available in the device, additional analysis could be done if the device also served as the storage location for the archival information on the monitors being read.

In one embodiment, the data collector 14 would have a communications link available directly to the central database repository 15, so information may be passed back to the database as soon as it is required or scheduled to do so. In this case, the portable configuration device 16 mainly serves the purpose of setting up initial identification and configuration settings, as well as modifying those same settings as they change during the operation of the hive. One other function performed by the configuration device is as a quick reading tool. This functionality is typically done to an individual monitor (although it may be done with a collector), such that an individual reading of a certain measurement parameter may be made and immediately reported. This functionality would be available on any hardware configuration as long as there is a monitor or collector available to be read.

The central database repository 15 is expected to be on a commonly available location, typically expected to be a server on the Internet. This common location is the portal from which a user may view and analyze information collected from the hive monitors. It is also the expected location where a user can remotely control configuration settings for the data Collector 14 and hive monitors within the user's system. In addition to receipt of the measured parameters, the CDR 15 also serves as an archive for the received information, and the point from which alarms are acted upon. There are multiple types of alarms in the system. Some alarms indicate that a configuration parameter has changed, or that a component of a hive has been changed. But there are also alarms that indicate a significant event has occurred that needs to be addressed immediately, such as a large unexplained weight change, the triggering of a tilt sensor (theft, wind damage or bear attack for example), or an unacceptable temperature within the hive. These later alarms are for conditions that may require immediate attention at the hive site. The CDR 15, and associated controlling program, allow various alarms to be handled in whatever manner the user chooses. This may include ignoring the alarm, displaying the alarm on a user interface, sending a message to the user (via email, pager, SMS text messaging, or any future methodology), or activating some automatically controlled equipment, such as an automatic feeder or a ventilation fan.

Analysis of the information for the various hive monitors will show how different parameters change with respect to each other in the normal operation of a hive. Usage of the optional information, such as the hive identification, may allow analysis of a specific hive over an extended period of time, and across multiple Hive monitors. This is useful for commercial beekeepers where hives may be transported to a variety of locations over the year. It may also be useful in being able to tell which hives went to certain locations in case there are larger hive failure rates (Colony Collapse Disorder) over the winter period for different locations.

The user interface to the CDR 15 will also allow the information to be exported in a variety of formats for the user to process in manners other than those already included in the program.

Although the present apiary monitoring system has been shown and described in considerable detail with respect to only a few exemplary embodiments thereof, it should be understood by those skilled in the art that we do not intend to limit the system to the embodiments since various modifications, omissions and additions may be made to the disclosed embodiments without materially departing from the novel teachings and advantages of the system, particularly in light of the foregoing teachings. Accordingly, we intend to cover all such modifications, omission, additions and equivalents as may be included within the spirit and scope of the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

We claim:

1. A system for monitoring one or more bee hives in an apiary, the apiary monitoring system comprising:
a hive monitor configured for measuring and transmitting data on hive parameters;
a data collector communicating with the hive monitor for logging measurement data received from the hive monitor, the data collector configured for transmitting the logged data; and
a central database repository communicating with the data collector for storing the logged data received from the data collector.

2. The apiary monitoring system as recited in claim 1, wherein the hive monitor passes alarm indications when detected to the data collector.

3. The apiary monitoring system as recited in claim 1, wherein the data collector transmits time and date synchronization information and any configuration changes to the hive monitor.

4. The apiary monitoring system as recited in claim 1, further comprising a wired connection from the hive monitor to the data collector.

5. The apiary monitoring system as recited in claim 1, further comprising low power wireless communication from the hive monitor to the data collector.

6. The apiary monitoring system as recited in claim 5, wherein the low power wireless communication comprises low power IEEE 802.15.4 RF communication.

7. The apiary monitoring system as recited in claim 1, wherein the communication between the data collector and central database repository is selected cell phone, satellite phone, telephone land line, WiFi, or combinations thereof.

8. The apiary monitoring system as recited in claim 1, wherein the central database repository comprises a server, and wherein the data collector is configured to access the interne for passing information to the central database repository.

9. The apiary monitoring system as recited in claim 1, further comprising a user interface

10. The apiary monitoring system as recited in claim 1, further comprising a portable configuration device for communicating with the hive monitor or the data collector or the central database repository.

11. A hive monitor for monitoring a bee hive, the hive monitor comprising
a controller;
a power source for powering the controller;
a load cell for measuring the weight of the hive;
means for measuring parameters of the hive; and
means for communicating measured data.

12. The hive monitor as recited in claim 11, wherein the parameters measured are selected from weight, temperature, humidity, physical location, GPS coordinates, positioning, physical orientation of hive, acoustic information, and combinations thereof.

13. The hive monitor as recited in claim 11, wherein the communicating means is hard wired.

14. The hive monitor as recited in claim 11, wherein the communicating means is low power wireless.

15. The hive monitor as recited in claim 14, wherein the low power wireless communication comprises IEEE 802.15.4 wireless communications.

16. The hive monitor as recited in claim 14, wherein the low power wireless communication comprises Bluetooth wireless communications.

17. A data collector for use in an apiary monitoring system for monitoring one or more bee hive monitors, the data collector comprising:
a controller;
a power source for powering the controller;
means for low power communication;
a user interface including means for user input; and
non-volatile memory for storing logged data readings from the hive monitors.

18. The data collector as recited in claim 17, further comprising a communication path for transmitting data externally of the data collector.

19. The data collector as recited in claim 18, wherein the communication path comprises cellular communications module, and an external antenna.

20. The data collector as recited in claim 18, wherein the communication path comprises a satellite communications module, and an external antenna.

21. The data collector as recited in claim 18, wherein the communication path comprises a WiFi module, and an external antenna.

22. The data collector as recited in claim 17, further comprising a portable configuration device for communicating with the data collector.

23. The data collector as recited in claim 17, wherein the power source comprises a solar panel.

24. The data collector as recited in claim 17, further comprising a weather station interface for recording general weather information for the apiary.

25. The data collector as recited in claim 17, wherein the low power communication means comprises an antenna for low power RF (IEEE 802.15.4) communication.

26. The data collector as recited in claim 17, wherein the low power communication means comprises a low power RF module (Bluetooth), and an antenna for Bluetooth communications.

27. A method of operating of a monitor for a bee hive for use in an apiary monitoring system, the hive monitor operating method comprising the steps of:
selecting a measurement to be made of a parameter of the beehive;
performing the measurement of the parameter;
determining if the measurement has an alarm condition to be tested; and
testing the measurement for the alarm condition.

28. The hive monitor operating method as recited in claim 27, further comprising the steps of providing a log buffer, time-stamping and logging the alarm condition into the log buffer.

29. The hive monitor operating method as recited in claim 27, further comprising the step of determining if the alarm condition requires an immediate report

30. The hive monitor operating method as recited in claim 27, further comprising the steps of providing a data collector, and reporting the measured parameter to the data collector.

31. The hive monitor operating method as recited in claim 27, further comprising the steps of determining an alarm condition, receiving a beacon signal from the data collector, and signaling a service alarm request to the data collector after receiving the beacon signal.

32. The hive monitor operating method as recited in claim 27, further comprising the step of determining if the measurement is to be logged.

33. The hive monitor operating method as recited in claim 27, further comprising the steps of providing a log buffer, and time-stamping and logging the measurement into the log buffer

34. The hive monitor operating method as recited in claim 33, wherein the log buffer is a circular buffer, and further comprising the steps of determining is the circular buffer has wrapped over unreported log data, and setting an alarm condition for a log buffer overflow condition.
